(19) United States
(12) Patent Application Publication
(10) Pub. No.: US 2006/0044139 A1
(43) Pub. Date: Mar. 2, 2006

(54) Internet accessible mail box system

(76) Inventors: John Quincy St. Clair, San Juan, PR (US); Michael Panzardi, San Juan, PR (US)

Correspondence Address: JOHN ST. CLAIR, 52 KINGS COURT, 4A, SAN JUAN, PR, 00911, US

(21) Appl. No.: 10/925,195

(22) Filed: Aug. 24, 2004

(51) Int. Cl. G08B 13/14; G08B 1/00; G08B 13/18; G01N 21/86

(52) U.S. Cl. 340/569; 340/531; 340/556; 250/559.4

(57) ABSTRACT

An Internet-embedded mail box system which transmits mail and package delivery information to a central server that can be accessed by wireless communication devices to determine if any mail is ready for pickup.

### BRIEF SUMMARY OF THE INVENTION

This invention is a commercial mail box system that transmits mail and package delivery information to an Internet server which can be accessed by wireless communication devices to know when mail is ready for pickup.

### BACKGROUND OF THE INVENTION

At the present moment, a person who rents a commercial mail box is forced every single time to have to personally visit the mail box rain, wind, storm, traffic jam or no parking in order to determine whether or not he or she has mail in the box. With the advent of wireless communication devices such as laptop computers, personal data assistants and Internet cellular telephones, a person can access an Internet website with these portable communication devices in order to obtain mail and package delivery information. As described in this invention, a mail box is fitted with an optical, electronic transmitting device which detects whether or not any letters or package delivery notices are in the box. If so, the device transmits this information to the Internet server which the user can access to determine whether or not it is necessary to travel all the way there for pickup. Thus the invention avoids unnecessary trips, summons for double parking, traffic congestion, and saves gasoline, time and money. By knowing that the package has been delivered before making a trip, usually in vain, personal stress is avoided. By knowing that the package the person was expecting has not arrived, the person can take that time to go to lunch or return home after a long and tedious workday.

### SUMMARY OF THE INVENTION

Referring to FIG. 1, the invention consists of a frame (A) containing mail boxes (B) attached to each other physically and electronically. Referring to FIG. 2, an individual box (A) contains two rectangular cutouts (B,C) centered in the bottom edge of the box. Referring to FIG. 3, an electronic circuit board (C) is attached by aluminum offsets to the bottom of the box (A). A light emitting diode (LED) (D), which forms part of the circuit board, sends a beam of light to the photocell (E) located directly across from (D) in the opposite slot in the box.

Referring to FIG. 4, looking along the main axis of the mail box (A), containing bottom edge slots (B,C), a piece of correspondence (I) interrupts light beam (H) emitted from LED (F) so that photocell (G) receives no light. The resistance of the photocell increases which is detected by circuit board (D) and electronic board components (J).

Referring to FIG. 5, the detector circuit consists of a 5 volt supply with a voltage divider consisting of resistor (R1) connected to the supply, and photocell (R2) connected to ground (0V). Semiconductor chip (Maxim DS2401) detects the voltage on line (3). If the photocell receives light, the resistance decreases and line (3) detects zero voltage which is interpreted as a logic 0 level on the one wire data bus (2) corresponding to no mail. If the photocell receives no light corresponding to having a piece of correspondence in the mail box, the resistance increases and line (3) detects the supply voltage which is interpreted as a logic 1 level on the one wire data bus (2). All mail boxes are connected to the same one wire bus (2).

Referring to FIG. 6, all the mail box one-wire DS2401 switches (U1,U2) are connected in parallel to the Dallas TINI microcontroller through the One Wire Bus and the ground line (Gnd). Each switch has a unique identification number burned into its memory during manufacture. During manufacture of the mail boxes, the TINI microcontroller determines all the identification numbers and their corresponding mail box numbers using a binary tree search of the switches. These two corresponding numbers are stored in non-volatile memory in the TINI microcontroller together with the identification number of the TINI. At a predetermined time each day, the microcontroller polls each identification number on the one wire bus to determine the status of the data line (2) to see if there is any mail in a particular box. This information is coded in a record in memory as follows:

TINI microcontroller six digit identification number (XXXXXX)

Mail box four digit identification number (XXXX)

Date (MMDDYY)

Referring to FIG. 7, the abovementioned record for each mail box having mail is transmitted over an Ethernet cable from the TINI microcontroller to the modem (Hub). A telephone cable or wireless antenna/satellite connects the modem to the Internet. The microcontroller implements the Transmission Control Protocol/Internet Protocol (TCP/IP) networking Java communication software interface in order to connect to the Internet Service Provider (ISP). The TCP manages the assembling of a message or file into smaller packets that are transmitted over the Internet and received by a TCP server program that reassembles the packets into the original message. The IP handles the address part of each packet so that it gets to the right destination.

Referring to FIG. 8, the information in the abovementioned record is transmitted to the Mail Box Server through the ISP and server hub. The server implements a Java client listener software routine which detects these incoming transactions and stores them in a transaction file located on hard disk. The server is a large mail box database system consisting of the following files:

(1) Client File
(a) Name
(b) Mailing Address
(c) Billing Address
(d) Telephone Number
(e) Store Identification Number
(f) Mail Box Identification Number
(g) Password
(h) Phone Card Service (Yes or No)
(i) Client Identification Number

(2) Mail Delivery Transaction File
(a) Store Identification Number (TINI ID)
(b) Mail Box Identification Number
(c) Date

(3) Package Delivery File
(a) Store Identification Number (TINI ID)
(b) Mail Box Identification Number
(c) Mail Delivery Company (UPS, FEDEX, USPS, DHL)
(d) Envelope or Package Code (E, P)
(e) Tracking Number
(f) Charges due
(g) Date

(4) Billing File
(a) Client Identification Number
(b) Date of transaction (YYMMDD)
(c) Amount
(d) Description of transaction
(e) Transaction type (debit, credit)
(f) Check number

The Mail Box server also processes user inquiries using a standard Internet program such as Microsoft's Internet Explorer with a website name such as www.mailbox.com. On a wireless laptop or desktop computer, the user enters his or her identification number and password. The server then looks up the client record and verifies the password. If the password is valid, the server uses the store and mailbox identification numbers found in the client file to access the mail and package delivery files whose information is formatted and displayed on the user's screen.

### A BRIEF DESCRIPTION OF THE DRAWINGS

FIG. 1. Perspective view of mail boxes.

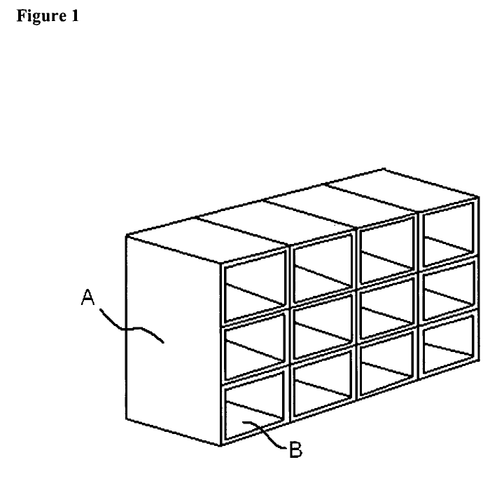

FIG. 2. Perspective view of individual mail box.

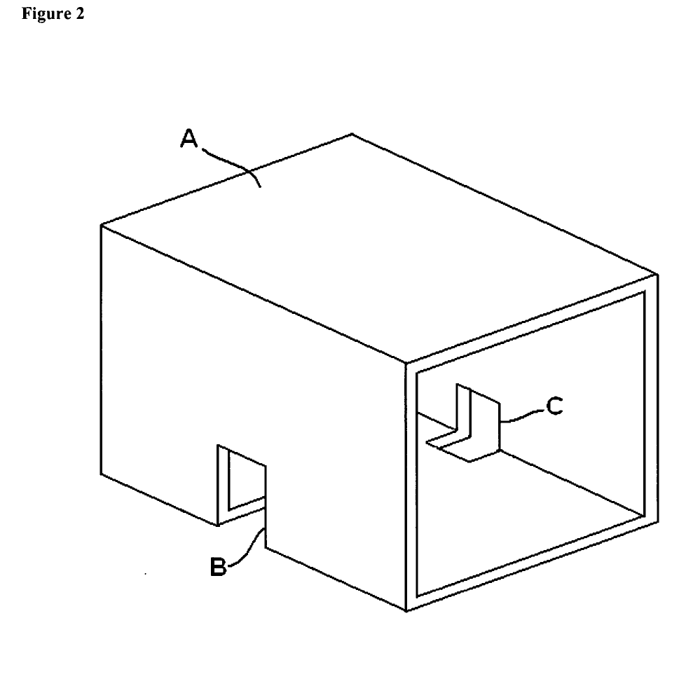

FIG. 3. Perspective view of mail box, circuit board, photocell and LED.

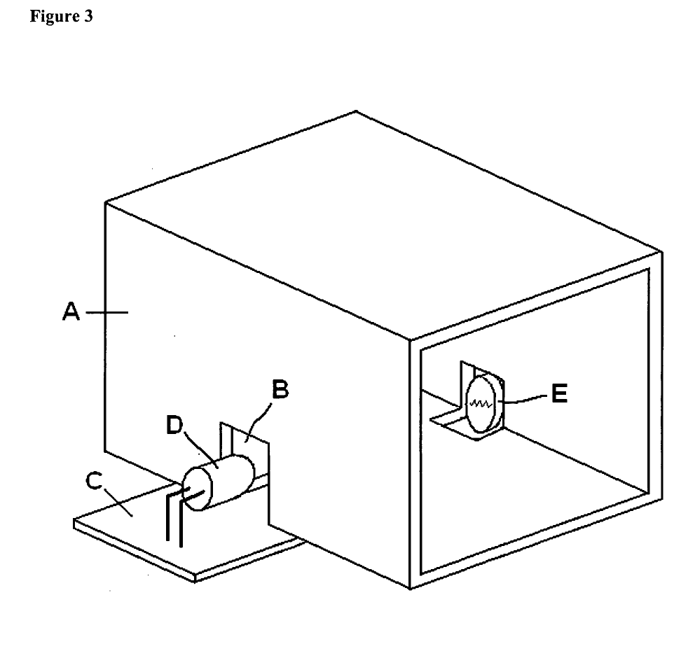

FIG. 4. End view of mail box showing interruption of LED light beam.

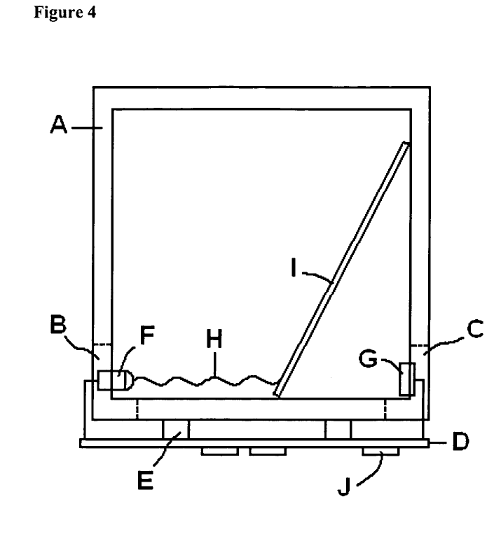

FIG. 5. Schematic drawing of circuit board.

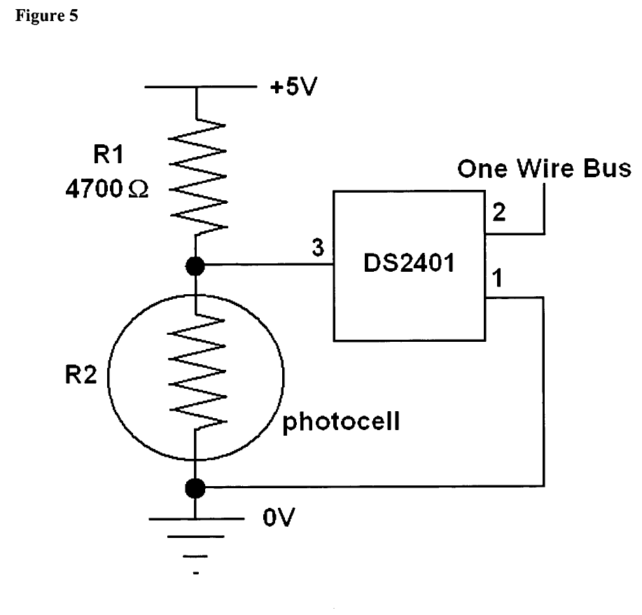

FIG. 6. Schematic drawing of TINI microcontroller and one-wire switches.

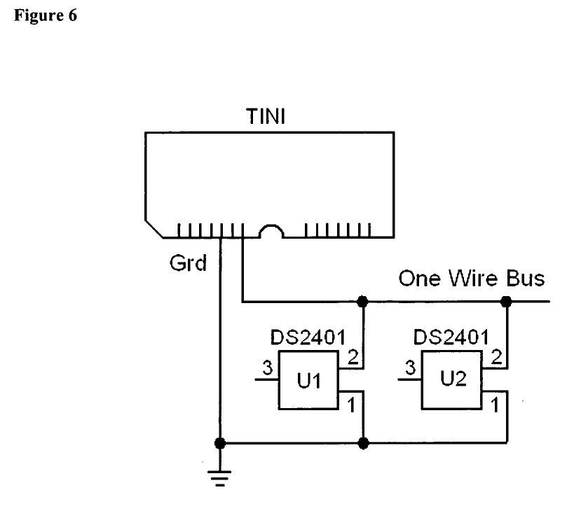

FIG. 7. Schematic drawing of microcontroller connected to Internet.

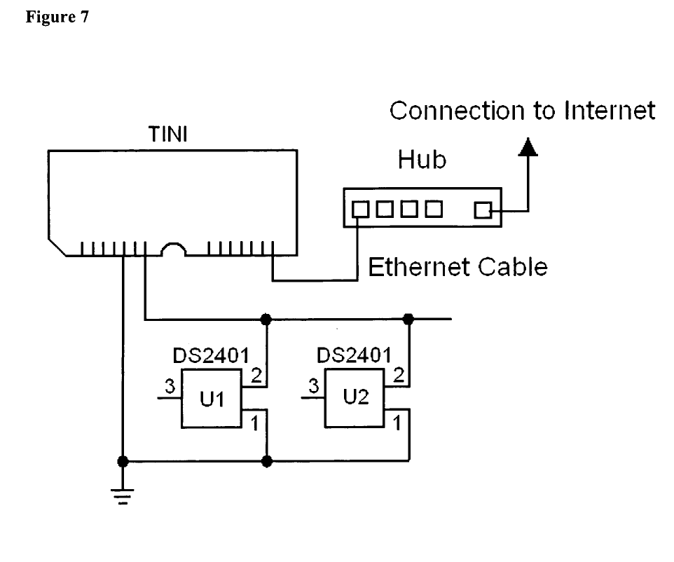

FIG. 8. Schematic drawing of Mail Box server connected to Internet.

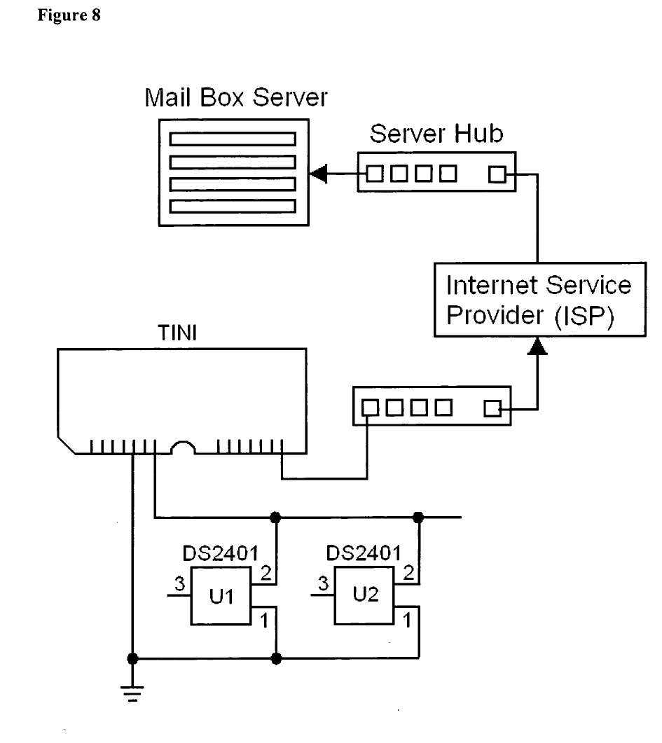

FIG. 9. Schematic drawing of dual port switch and LED.

FIG. 10. Drawing of thin aluminum sheet for making mail box.

FIG. 11. Perspective view of 1-wire bus connecting circuit boards.

FIG. 12. Schematic drawing of package delivery system.

### DETAILED DESCRIPTION OF THE INVENTION

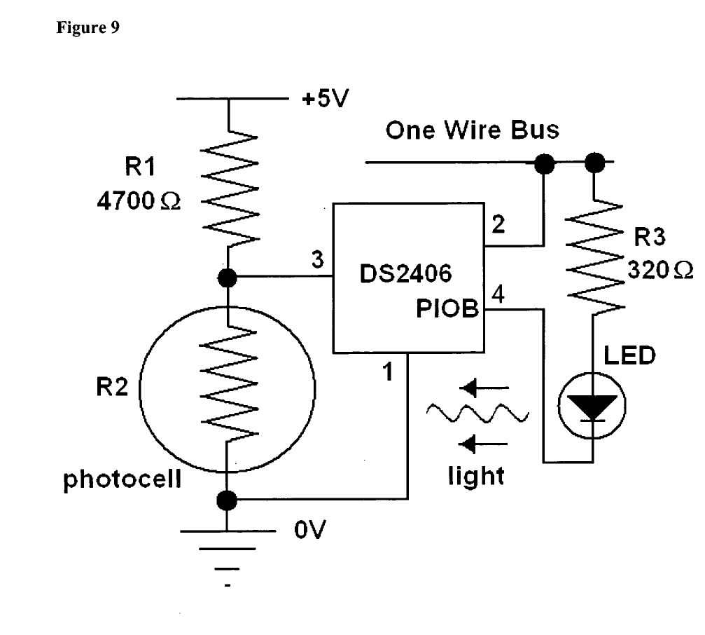

1. Referring to FIG. 9, the Maxim DS2406 semiconductor is a dual port switch having one extra data port (PIOB, line 4) compared to the single port DS2401. This extra port allows the TINI microcontroller to activate the light emitting diode (LED) only when the mail box is read. The microcontroller places a logic 0 on line 4 which grounds the LED. Current flows through resistor R3 and the forward biased LED such that light is emitted toward photocell (R2). The microcontroller then reads line 3 to determine if there is mail in the box. The LED is turned off by placing a logic 1 on line 4. Because the LED is used for only a short time period each day, the life of the diode is increased substantially.

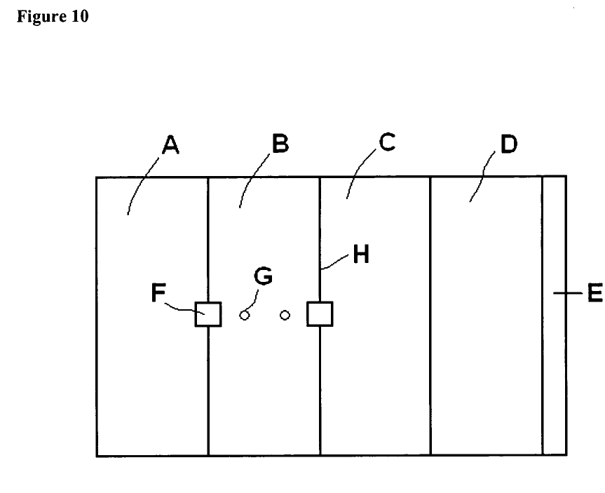

2. Referring to FIG. 10, the mail box is cut with metal shearing equipment from a sheet of thin aluminum. A die and punch are used to cut out the rectangular holes (F) for the optics. Two holes (G) are threaded to attach the circuit board to the box using an aluminum offset and screw. The left side (A), bottom (B), right side (C), top (D) and riveting flange (E) are creased along four lines (H) to form the box. The box and attached circuit board slide into the mail box frame as a single unit.

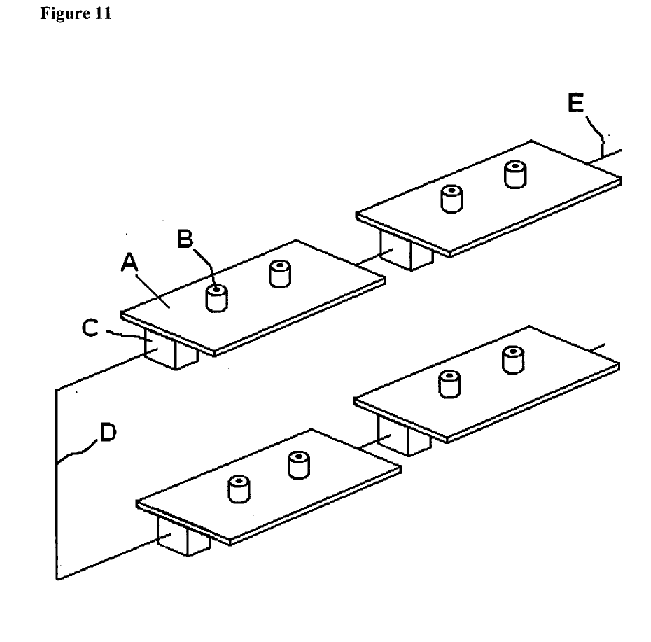

3. Referring to FIG. 11, the circuit boards (A) are attached physically to their respective mail box using a spacer and screw (B). The aluminum spacer acts as a ground line to the electrically grounded mail box frame. An RJ-11 board connector on each circuit board routes the one-wire bus and +5V power supply line (D) sequentially through all the boards and to the microcontroller (E).

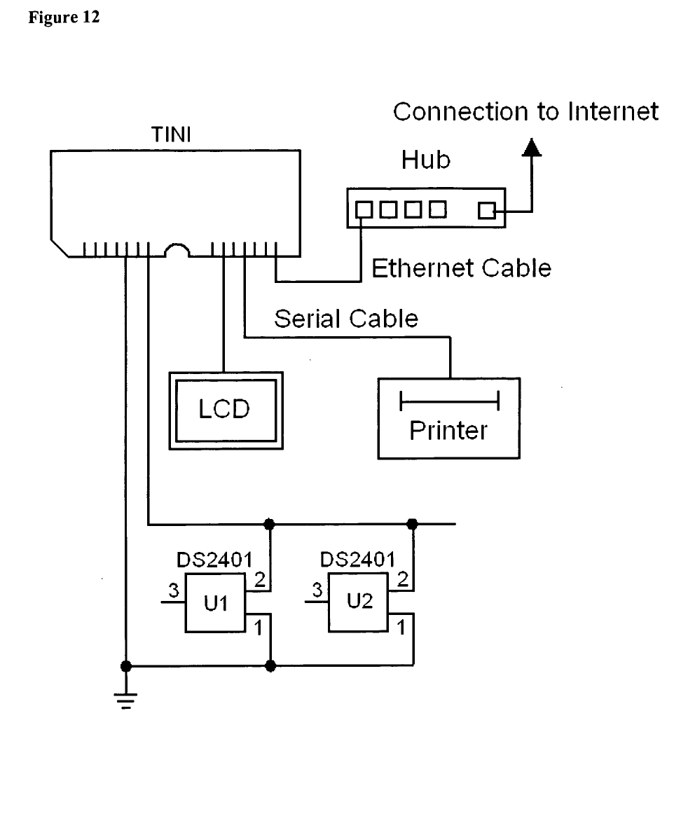

4. Referring to FIG. 12, a liquid crystal display/numeric keypad (LCD) and printer are connected to the TINI microcontroller to obtain package delivery information. The mail box attendant enters the box number, the shipping company such as UPS, FEDEX, USPS or DHL, the type of package such as envelope or package, date of arrival, charges due, and the tracking number. After completing the information, a delivery notice is printed out on the printer for insertion into the mail box. After adding the TINI identification and mail box number to the record, the microcontroller transmits the information over the Internet to the mail box server. This information is then stored in the aforementioned package delivery file.

5. As an additional service, the Mail Box server contains a voice response communications card which allows the server to call the user over a telephone modem and provide mail and package delivery information by electronic voice mail.

I claim:

1. An Internet-embedded mail box system comprising:
a. a rectangular mail box frame;
b. item (a) containing a plurality of individual slide-in rectangular mail boxes made of folded thin aluminum sheet fitted with a swinging key-locked door on one side and open on the other for inserting pieces of correspondence into the boxes;
c. each mail box of item (b) containing two rectangular slots on opposite sides in the center bottom edges or other convenient location in order to provide an optical path from one slot to the other;
d. an electronic circuit board attached by aluminum spacers and screws to the bottom of each mail box of item (b);
e. an electronic circuit residing on item (d) comprising a light emitting diode (LED) on one side and a photocell on the other which provides a means of emitting and detecting a light beam across the mail box using the slots of item (c);
f. item (e) comprising a means of detecting a piece of correspondence in the mail box by interruption of the light beam;
g. item (e) comprising a +5 volt voltage divider consisting of a resistor and resistive photocell;
h. item (g) whose dividing voltage between the two components is measured by the first port on a two port switch, preferably a Maxim DS2406 chip, having a unique access identification number burned into its memory during manufacture, which transmits the logic level of one or zero, corresponding to the measured voltage level, along a 1-wire bus to a microcontroller connected by modem to the Internet;
i. item (h) logic level 1 corresponding to having mail, and logic level 0 to having no mail;
j. item (e) comprising a resistor from the power supply to the light emitting diode (LED) which in turn is connected to the second port of the dual port switch item (h) for the purpose of activating and deactivating the LED by means of the switch's unique identification number transmitted through the 1-wire bus by the microcontroller item (h);
k. item (h) microcontroller which transmits, using TCP/IP protocol and an Internet Service Provider (ISP), a record consisting of the microcontroller number (store number), mail box number and date to the mail box server which stores the information on hard disk in a transaction file;
l. item (h) microcontroller connected to liquid crystal display, numeric keypad and printer for the purpose of collecting and printing package delivery information which is transmitted by the microcontroller to the mail box server item (2) below;
m. a Java binary-tree search program used during manufacture to relate the mail box number with the unique identification number of the dual port switch of each mail box for storage in the microcontroller's non-volatile memory;

2. a Mail Box server comprising:
a. a multi-processor RAID computer system connected to the Internet by modem;
b. a database system running on item (a) consisting of the following files:
1. client master file,
2. mail delivery transaction file,
3; package delivery transaction file,
4. billing file;
c. a Java listener software program which listens for and processes transactions transmitted over the Internet by the microcontrollers;
d. a Java software program which processes client mail delivery inquiries through the Internet, using a client identification number and password, and displays the information on the client's screen in order for the client to know if any mail is ready for pickup.
